(19) United States
(12) Patent Application Publication
(10) Pub. No.: US 2011/0236666 A1
(43) Pub. Date: Sep. 29, 2011

(54) MELT-EXTRUDED FILM

(76) Inventors: Mark J. Hall, Midland, MI (US); Michael D. Read, Midland, MI (US); Uma Shrestha, Bay City, MI (US)

(21) Appl. No.: 13/035,233

(22) Filed: Feb. 25, 2011

Related U.S. Application Data
(60) Provisional application No. 61/317,899, filed on Mar. 26, 2010.

(51) Int. Cl. B29C 47/14; B32B 27/00; B32B 5/00

(52) U.S. Cl. 428/220; 264/177.17

(57) ABSTRACT

A melt-extruded film is produced by a process which comprises the steps of blending a) a water-soluble polymer, b) an active ingredient, and c) optional additives and subjecting the blend to melt-extrusion to produce an extruded melt and drawing the extruded melt at a draw-down ratio of from 1.5 to 20 to a film of a thickness of at least 0.04 mm.

### CROSS-REFERENCE TO RELATED APPLICATION(S)

This application claims benefit of priority from U.S. Provisional Patent Application No. 61/317,899, filed Mar. 26, 2010, which application is incorporated by reference herein in its entirety.

### FIELD OF THE INVENTION

This invention relates to a process for producing melt-extruded films.

### BACKGROUND OF THE INVENTION

Active ingredients, such as drugs or pharmaceuticals, may be prepared in a tablet form to allow for accurate and consistent dosing. However, this form of preparing and dispensing medications has many disadvantages including that a large proportion of adjuvants that must be added to obtain a size able to be handled, that a larger medication form requires additional storage space, and that dispensing includes counting the tablets which has a tendency for inaccuracy. In addition, many persons have difficulty swallowing tablets. While tablets may be broken into smaller pieces or even crushed as a means of overcoming swallowing difficulties, this is not a suitable solution for many tablet or pill forms. For example, crushing or destroying the tablet or pill form to facilitate ingestion, alone or in admixture with food, may also destroy the controlled release properties.

As an alternative to tablets and pills, films may be used to carry active ingredients. However, historically films and the process of making drug delivery systems there from have suffered from a number of unfavorable characteristics that have not allowed them to be used in practice. U.S. Patent Application Publication No. 2005/037055 discusses in detail in paragraphs [0005]-[0012] disadvantages of known films, such as agglomeration of film components which leads to an inhomogeneous distribution of the active ingredient or non-uniform films, particularly if the films are relatively thick. Non-uniform films are caused by conventional techniques for drying aqueous polymer solutions to produce a film, wherein the surface water is immediately evaporated forming a polymer film or skin. Evaporation of remaining water vapor under the surface of the film results in repeated destruction and reformation of the film surface, which is observed as a “ripple effect” which produces an uneven film. To solve these problems US 2005/037055 suggests the production of rapid-dissolving film products comprising a water-soluble polyethylene oxide alone or in combination with a hydrophilic cellulosic polymer which is free of added plasticizer. Polymer, water, and an active or other component is formed into a sheet or film by coating, spreading, casting or drawing the multi-component matrix and drying the film from the bottom of the film to the top of the film. Alternatively the film is formed by extrusion. According to the examples of US 2005/037055 rapid dissolving thin films having a content of an active ingredient of less than 5% by weight were produced by roll coating. While the taught drying method may be useful to obtain a uniform film, US 2005/037055 does not address the problem of efficiently producing films in which a large and controlled amount of active ingredient can be integrated.

### SUMMARY OF THE INVENTION

One aspect of the present invention is a process for producing a melt-extruded film which comprises the steps of blending a) a water-soluble polymer, b) an active ingredient, and c) optional additives and subjecting the blend to melt-extrusion to produce an extruded melt and drawing the extruded melt at a draw-down ratio of from 1.5 to 20 to a film of a thickness of at least 0.04 mm. Another aspect of the present invention is a melt-extruded film producible according to the above-mentioned process.

### DETAILED DESCRIPTION OF THE INVENTION

In a first step of the process of the present invention for producing a melt-extruded film a) a water-soluble polymer, b) an active ingredient, and c) optional additives are blended. Preferably a blend is produced that comprises from 10 to 99 percent, more preferably from 15 to 90 percent, and most preferably from 40 to 80 percent of a water-soluble polymer a), preferably from 1 to 70 percent, more preferably from 10 to 60 percent, and most preferably from 20 to 40 percent of an active ingredient b) and preferably from 0 to 50 percent, more preferably from 5 to 45 percent, and most preferably from 10 to 40 percent of an optional additive c), based on the total weight of the blend.

The combined amount of the water-soluble polymer a) and the active ingredient b) is preferably at least 75 percent, more preferably at least 85 percent, and most preferably at least 95 percent, based on the total weight of the blend. The blend can comprise one or more of the water-soluble polymers a), one or more of the active ingredients b), and one or more of the optional additives c), however their total amount is generally within the above-mentioned ranges.

The water soluble polymer a) generally has a solubility in water of at least 1 grams, more preferably at least 3 grams, most preferably at least 5 grams in 100 grams of distilled water at 25° C. and 1 atmosphere. The water-soluble polymer a) is preferably selected from one or more polysaccharides, gelatins, poly(amino acids), such as poly(aspartic acid) or poly(glutamic acid); polylactic acid or a salt of such a polymerized acid or one or more synthetic polymers selected from the group consisting of polyalkylene oxides, such as ethylene oxide homo- and copolymers having a weight average molecular weight of at least 10,000, and homo- and copolymers comprising in polymerized form an unsaturated acid or a salt thereof, such as acrylic acid, methacrylic acid, or a salt thereof, an unsaturated amide, such as acrylamide; a vinyl ester, a vinylalcohol, an acetate, such as vinylacetate; an alkylene imine, such as ethylene imine; an oxyethylene alkylether, a vinylpyrrolidone, vinyloxazolidone, vinylmethyloxazolidone, ethylene sulfonic acid, a vinylamine, vinylpyridine, an ethylenically unsaturated sulfate or sulfonate or a combination of one or more of these polymers.

The water-soluble polymer generally has a weight average molecular weight of at least 15,000 g/mol, preferably at least 20,000 g/mol, more preferably at least 25,000 g/mol, most preferably at least 30,000 g/mol. The preferred upper limit for the weight average molecular weight largely depends on the type of polymer. Generally the weight average molecular weight of the water-soluble polymer is up to 10,000,000 g/mol, preferably up to 8,000,000 g/mol, more preferably up to 5,000,000 g/mol. The weight average molecular weight can be determined by light scattering according to the Standard Test Method ASTM D-4001-93 (2006).

One preferred type of water-soluble polymer a) is a polysaccharide. Examples of polysaccharides include gum arabic, xanthan gum, gum karaya, gum tragacanth, gum ghatti, carrageenan, dextran, alginates, agar, gellan gum, gallactomannans such as guar gum, pectins, starches, starch derivatives, guar derivatives and xanthan derivatives. Starch derivatives, guar derivatives and xanthan derivatives are described in more detail in European patent EP 0 504 870 B, page 3, lines 25-56 and page 4, lines 1-30. Useful starch derivatives are for example starch ethers, such as hydroxypropyl starch or carboxymethyl starch. Useful guar derivatives are for example carboxymethyl guar, hydroxypropyl guar, carboxymethyl hydroxypropyl guar or cationized guar. Preferred hydroxypropyl guars and the production thereof is described in U.S. Pat. No. 4,645,812, columns 4-6. Preferred polysaccharides are cellulose esters or cellulose ethers. Preferred cellulose ethers are carboxy-C₁-C₃-alkyl celluloses, such as carboxymethyl celluloses; carboxy-C₁-C₃-alkyl hydroxy-C₁-C₃-alkyl celluloses, such as carboxymethyl hydroxyethyl celluloses; C₁-C₃-alkyl celluloses, such as methylcelluloses; C₁-C₃-alkyl hydroxy-C₁₋₃-alkyl celluloses, such as hydroxyethyl methylcelluloses, hydroxypropyl methylcelluloses or ethyl hydroxyethyl celluloses; hydroxy-C₁₋₃-alkyl celluloses, such as hydroxyethyl celluloses or hydroxypropyl celluloses; mixed hydroxy-C₁-C₃-alkyl celluloses, such as hydroxyethyl hydroxypropyl celluloses, or alkoxy hydroxyethyl hydroxypropyl celluloses, the alkoxy group being straight-chain or branched and containing 2 to 8 carbon atoms. Most preferably, the composition comprises a water-soluble cellulose ether, such as a methylcellulose with a methyl degree of substitution DS_{methoxyl} of from 1.2 to 2.2, preferably from 1.5 to 2.0, or a hydroxypropyl methylcellulose with a DS_{methoxyl} of from 0.9 to 2.2, preferably from 1.1 to 2.0 and a MS_{hydroxypropoxyl} of from 0.02 to 2.0, preferably from 0.1 to 1.2. Generally the weight average molecular weight of the polysaccharide is up to 5,000,000 g/mol, preferably up to 500,000 g/mol, more preferably up to 300,000 g/mol.

Another preferred type of water-soluble polymer is a polyethylene oxide. The term “polyethylene oxide” as used herein includes homo- and copolymers of ethylene oxide. The ethylene copolymer may be a random copolymer produced by the polymerization of ethylene oxide mixed with at least one other oxide, such as 1,2-cyclohexene epoxide, 1,2-butene epoxide, allyl glycidyl ether, glycidyl methacrylate, epichlorohydrin, 1,3-butadiene diepoxide, styrene oxide, 4-vinyl-1-cyclohexene 1,2-epoxide, 4-(2-trimethoxysilylethyl)-1,2-epoxycyclohexene and 4-vinyl-1-cyclohexene diepoxide, preferably an alkylene oxide, such as propylene oxide, 1,2-butene epoxide, or isobutylene oxide. Other useful ethylene oxide copolymers are block copolymers produced by the sequential addition of ethylene oxide and at least one other alkylene oxide, in which nearly total consumption of the first monomer takes place prior to the addition of subsequent monomer(s). Alternatively, the ethylene oxide copolymer may comprise in copolymerized form ethylene oxide and another copolymerizable monomer, such as methyl acrylate, ethyl acrylate, a caprolactone, ethylene carbonate, trimethylene carbonate, 1,3-dioxolane, carbon dioxide, carbonyl sulfide, tetrahydrofuran, methyl isocyanate, or methyl isocyanide. Preferred ethylene oxide copolymers are copolymers of ethylene oxide with epichlorohydrin or copolymers of ethylene oxide with cyclohexene oxide. Ethylene oxide copolymers generally comprise at least about 50 mole percent, preferably at least about 70 mole percent, more preferably at least about 85 mole percent ethylene oxide units. The most preferred ethylene oxide polymers are ethylene oxide homopolymers. The polyethylene oxide preferably has a weight average molecular weight of from about 50,000 g/mol, to about 10,000,000 g/mol, more preferably from about 70,000 g/mol, to about 8,000,000 g/mol, most preferably from about 90,000 g/mol, to about 5,000,000 g/mol. Polyethylene oxides useful in the present composition are commercially available from The Dow Chemical Company. The average molecular weight of the polyethylene oxide employed will generally affect the processing conditions selected. A very high average molecular weight polyethylene oxide, such as greater than about 5,000,000 g/mol, will generally require higher processing temperature, torque and/or pressure in the extrusion process than a polyethylene oxide having an average molecular weight less than or equal to about 5,000,000 g/mol.

More preferably, the water-soluble polymer is an above-described cellulose ether or an above-described polyethylene oxide, a polyvinylpyrrolidone or a polymer comprising in polymerized form acrylic acid, methacrylic acid, a salt of acrylic acid or methacrylic acid, vinylacetate, ethylene imine, or an oxyethylene alkylether. Most preferably, an above-described cellulose ether or an above-described polyethylene oxide or a combination of a cellulose ether and a polyethylene oxide is utilized in the production of the film of the present invention.

It has been found that the melt-extrusion process of the present invention works particularly well if a water-soluble polymer a) is chosen that has a softening point above the melting point of the active ingredient b) at atmospheric pressure. The softening point of the water-soluble polymer a) is measured according to Differential Scanning calorimetry (DSC). The softening point, as measured by DSC, is defined as the glass transition temperature for an amorphous polymer or the crystalline melting point for a semicrystalline polymer. Preferably a water-soluble polymer a) is chosen that has a softening point that is at least 10° C. higher, more preferably at least 20° C. higher, most preferably at least 50° C. higher than the melting point of the active ingredient. The polymer composition may contain a plasticizer to render it hot-melt extrudable. The plasticizer should be able to lower the glass transition temperature or softening point of polymer in order to allow for lower processing temperature, extruder torque and pressure during the hot-melt extrusion process. However, the amount and type of plasticizer should generally be chosen such that the glass transition temperature or softening point is not decreased to an undue extent. The softening point of the water-soluble polymer a) reduced by the plasticizer preferably is still at least 10° C. higher, more preferably at least 20° C. higher than the melting point of the active ingredient.

A large variety of active ingredients can be included in the blend for producing the melt-extruded film, preferably biologically active ingredients, particularly health-related biologically active ingredients, such as vitamins, herbals and mineral supplements, oral care ingredients and drugs, but also active ingredients not directly related to health, such as flavors, colors, taste masking compounds, cosmetically active ingredients, or ingredients active in agriculture. The active ingredient includes hydrophobic, hydrophilic and amphiphilic compounds. It is not necessary for the active ingredient to be soluble in any given component of the composition. The active ingredient may be dissolved, partially dissolved or suspended in the polymer matrix of the composition. The active ingredient should generally be stable during the melt extrusion process conditions used. By stable, it is meant that a significant portion of the active ingredient will not be significantly degraded or decomposed throughout the melt extrusion process. Surprisingly, it has been found that the melt-extruded film of the present invention can have a high load of the active ingredient, for example from 1 to 70 percent, more preferably from 10 to 60 percent, and most preferably from 20 to 40 percent, based on the total weight of the film, and that a melt-extruded film can still be produced. The resulting film is advantaged in that a given area of film contains a high concentration of active ingredient, thus fewer film strips are required to provide an effective dose. Further, higher active ingredient concentration in the film provides faster availability of the active ingredient as less polymer must be dissolved before the film disintegrates.

The active ingredients which may be incorporated in the composition to be melt extruded may be used for treating indications such as, by way of example and without limitation, inflammation, gout, hypercholesterolemia, microbial infection, AIDS, tuberculosis, fungal infection, amoebic infection, parasitic infection, cancer, tumor, organ rejection, diabetes, heart failure, arthritis, asthma, pain, congestion, urinary tract infections, vaginal infection, seizure related disorder, depression, psychosis, convulsion, diabetes, blood coagulation, hypertension and birth control.

The active ingredients which may be incorporated in the composition to be melt extruded may be used for treating indications such as, by way of example and without limitation, inflammation, gout, hypercholesterolemia, microbial infection, AIDS, tuberculosis, fungal infection, amoebic infection, parasitic infection, cancer, tumor, organ rejection, diabetes, heart failure, arthritis, asthma, pain, congestion, urinary tract infections, vaginal infection, seizure related disorder, depression, psychosis, convulsion, diabetes, blood coagulation, hypertension and birth control.

Examples of active ingredients that can be administered by the film of the present invention are, acebutolol, acetylcysteine, acetylsalicylic acid, acyclovir, alprazolam, alfacalcidol, allantoin, allopurinol, ambroxol, amikacin, amiloride, aminoacetic acid, amiodarone, amitriptyline, amlodipine, amoxicillin, ampicillin, ascorbic acid, aspartame, astemizole, atenolol, beclomethasone, benserazide, benzalkonium hydrochloride, benzocaine, benzoic acid, betamethasone, bezafibrate, biotin, biperiden, bisoprolol, bromazepam, bromhexine, bromocriptine, budesonide, bufexamac, buflomedil, buspirone, caffeine, camphor, captopril, carbamazepine, carbidopa, carboplatin, cefachlor, cefalexin, cefadroxil, cefazoline, cefixime, cefotaxime, ceftazidime, ceftriaxone, cefuroxime, selegiline, chloramphenicol, chlorhexidine, chlorpheniramine, chlortalidone, choline, cyclosporin, cilastatin, cimetidine, ciprofloxacin, cisapride, cisplatin, clarithromycin, clavulanic acid, clomipramine, clonazepam, clonidine, clotrimazole, codeine, cholestyramine, cromoglycic acid, cyanocobalamin, cyproterone, desogestrel, dexamethasone, dexpanthenol, dextromethorphan, dextropropoxiphene, diazepam, diclofenac, digoxin, dihydrocodeine, dihydroergotamine, dihydroergotoxin, diltiazem, diphenhydramine, dipyridamole, dipyrone, disopyramide, domperidone, dopamine, doxycycline, enalapril, ephedrine, epinephrine, ergocalciferol, ergotamine, erythromycin, estradiol, ethinylestradiol, etoposide, Eucalyptus globulus, famotidine, felodipine, fenofibrate, fenoterol, fentanyl, flavin mononucleotide, fluconazole, flunarizine, fluorouracil, fluoxetine, flurbiprofen, furosemide, gallopamil, gemfibrozil, gentamicin, Gingko biloba, glibenclamide, glipizide, clozapine, Glycyrrhiza glabra, griseofulvin, guaifenesin, haloperidol, heparin, hyaluronic acid, hydrochlorothiazide, hydrocodone, hydrocortisone, hydromorphone, ipratropium hydroxide, ibuprofen, imipenem, indomethacin, iohexyl, iopamidol, isosorbide dinitrate, isosorbide mononitrate, isotretinoin, itraconazole, ketotifen, ketoconazole, ketoprofen, ketorolac, labetalol, lactulose, lecithin, levocarnitine, levodopa, levoglutamide, levonorgestrel, levothyroxine, lidocaine, lipase, imipramine, lisinopril, loperamide, lorazepam, lovastatin, medroxyprogesterone, menthol, methotrexate, methyldopa, methylprednisolone, metoclopramide, metoprolol, miconazole, midazolam, minocycline, minoxidil, misoprostol, morphine, multivitamin mixtures or combinations and mineral salts, N-methylephedrine, naftidrofuryl, naproxen, neomycin, nicardipine, nicergoline, nicotinamide, nicotine, nicotinic acid, nifedipine, nimodipine, nitrazepam, nitrendipine, nizatidine, norethisterone, norfloxacin, norgestrel, nortriptyline, nystatin, ofloxacin, omeprazole, ondansetron, pancreatin, panthenol, pantothenic acid, paracetamol, penicillin G, penicillin V, phenobarbital, pentoxifylline, phenoxymethylpenicillin, phenylephrine, phenylpropanolamine, phenyloin, piroxicam, polymyxin B, povidone-iodine, pravastatin, prazepam, prazosin, prednisolone, prednisone, bromocriptine, propafenone, propranolol, proxyphylline, pseudoephedrine, pyridoxine, quinidine, ramipril, ranitidine, reserpine, retinol, riboflavin, rifampicin, rutoside, saccharin, salbutamol, salcatonin, salicylic acid, simvastatin, somatropin, sotalol, spironolactone, sucralfate, sulbactam, sulfamethoxazole, sulfasalazine, sulpiride, tamoxifen, tegafur, teprenone, terazosin, terbutaline, terfenadine, tetracycline, theophylline, thiamine, ticlopidine, timolol, tranexamic acid, tretinoin, triamcinolone acetonide, triamterene, trimethoprim, troxerutin, uracil, valproic acid, vancomycin, verapamil, vitamin E, folinic acid, zidovudine.

Preferred active ingredients are ibuprofen (as racemate, enantiomer or enriched enantiomer), ketoprofen, flurbiprofen, acetylsalicylic acid, verapamil, paracetamol, nifedipine, captopril, omeprazole, ranitidine, tramadol, cyclosporin, trandolapril and therapeutic peptides.

Analgesics include opiates and opiate derivatives, such as oxycodone (available as Oxycontin®), ibuprofen, aspirin, acetaminophen, and combinations thereof that may optionally include caffeine.

Other preferred active ingredients for use in the present invention include anti-diarrheals such as immodium AD, anti-histamines, anti-tussives, decongestants, vitamins, and breath fresheners. Common drugs used alone or in combination for colds, pain, fever, cough, congestion, runny nose and allergies, such as acetaminophen, chlorpheniramine maleate, dextromethorphan, pseudoephedrine HCl and diphenhydramine may be included in the film compositions of the present invention.

Also contemplated for use herein are anxiolytics such as alprazolam (available as Xanax®); anti-psychotics such as clozopin (available as Clozaril®) and haloperidol (available as Haldol®); non-steroidal anti-inflammatories (NSAID's) such as dicyclofenacs (available as Voltaren®) and etodolac (available as Lodine®), anti-histamines such as loratadine (available as Claritin®), astemizole (available as Hismanal™), nabumetone (available as Relafen®), and Clemastine (available as Tavist®); anti-emetics such as granisetron hydrochloride (available as Kytril®) and nabilone (available as Cesamet™); bronchodilators such as Bentolin®, albuterol sulfate (available as Proventil®); anti-depressants such as fluoxetine hydrochloride (available as Prozac®), sertraline hydrochloride (available as Zoloft®), and paroxtine hydrochloride (available as Paxil®); anti-migraines such as Imigra®, ACE-inhibitors such as enalaprilat (available as Vasotec®), captopril (available as Capoten®) and lisinopril (available as Zestril®); anti-Alzheimer's agents, such as nicergoline; and CaH-antagonists such as nifedipine (available as Procardia® and Adalat®), and verapamil hydrochloride (available as Calan®).

Active antacid ingredients include, but are not limited to, the following: aluminum hydroxide, dihydroxyaluminum aminoacetate, aminoacetic acid, aluminum phosphate, dihydroxyaluminum sodium carbonate, bicarbonate, bismuth aluminate, bismuth carbonate, bismuth subcarbonate, bismuth subgallate, bismuth subnitrate, bismuth subsilysilate, calcium carbonate, calcium phosphate, citrate ion (acid or salt), amino acetic acid, hydrate magnesium aluminate sulfate, magaldrate, magnesium aluminosilicate, magnesium carbonate, magnesium glycinate, magnesium hydroxide, magnesium oxide, magnesium trisilicate, milk solids, aluminum mono-ordibasic calcium phosphate, tricalcium phosphate, potassium bicarbonate, sodium tartrate, sodium bicarbonate, magnesium aluminosilicates, tartaric acids and salts.

Cosmetic active agents may include breath freshening compounds like menthol, other flavors or fragrances, especially those used for oral hygiene, as well as actives used in dental and oral cleansing such as quaternary ammonium bases. The effect of flavors may be enhanced using flavor enhancers like tartaric acid, citric acid, vanillin, or the like.

Examples of the range of such nutritional supplements usable in the invention include, but are not limited to, Cherry extract, Ginkgo biloba extract, Kava Kava extract, Ginseng extract, Saw Palmetto extract, cranberry or blueberry extract, tomato extract, cordyceps sinensis extract, pomegranates, elderberries, as well as the entire berry family, strawberry, raspberry, cherry, black raspberry, boysenberry, etc., glucosamine sulfate, chromium picolinate, Milk thistle extract, Grape seed extract, Ma Huang extract, Co-enzyme Q10, water soluble vitamins such as vitamin C niacin, vitamin B1 and vitamin B12, and fat soluble vitamins such as vitamins A, D, E, and K, minerals such as calcium, magnesium and zinc, among others.

Examples of active ingredients which are particularly suitable for including in the polymer composition to be melt extruded are ibuprofen (as racemate, enantiomer or enriched enantiomer), ketoprofen, flurbiprofen, acetylsalicylic acid, verapamil, paracetamol, nifedipine, captopril, omeprazole, ranitidine, tramadol, cyclosporin, trandolapril and therapeutic peptides.

When a polysaccharide, such as methyl cellulose or a hydroxypropyl methylcellulose is used as water-soluble polymer a), the active ingredient preferably has a melting point of less than 150° C. When a polyethylene oxide is used as water-soluble polymer a), the active ingredient preferably has a melting point of less than 65° C.

The blend to be melt-extruded may comprise one or more optional additives c), such as one or more disintegrants, fillers, pigments, colorants, lubricants, plasticizers, stabilizers such as antioxidants, slip agents and anti-block agents. However, one advantage of the present invention is that it is not necessary to incorporate one or more lubricants or plasticizers or stabilizers or slip agents or anti-block agents in the blend to be melt-extruded for preparing the film of the present invention.

A disintegrant can be incorporated as optional additive c) in the blend to be melt-extruded to reduce the disintegration or dissolution time of the produced melt-extruded film. Useful disintegrants are, as examples but not limited to, mono- and disaccharides, sugar alcohols, salts of cross-linked carboxymethylcellulose and water soluble polymers with a lower molecular weight than the water-soluble polymer a).

The blends of a), b) and optionally c) described herein are generally melt-extrudable. As used herein, the term “melt-extrudable” refers to a compound or composition that may be melt-extruded, particularly hot-melt extruded. A hot-melt extrudable polymer composition is one that is sufficiently rigid at 25° C. and atmospheric pressure, when it is not in particulate form such as a powder or granules, but is capable of deformation or forming a semi-liquid state under elevated heat or pressure, that means at a temperature above 25° C. or a pressure above atmospheric pressure. Although the polymer composition utilized for producing the film of the present invention need not contain a plasticizer to render it hot-melt extrudable, a plasticizer may be included as an additional component. The plasticizer should be able to lower the glass transition temperature or softening point of polymer in order to allow for lower processing temperature, extruder torque and pressure during the hot-melt extrusion process. Plasticizers also generally reduce the viscosity of a polymer melt thereby allowing for lower processing temperature and extruder torque during hot-melt extrusion. Useful plasticizers are, for example, cetanol, triglycerides, polyoxyethylene-polyoxypropylene glycol (Pluronic), triacetin or triethyl citrate. Plasticizers are advantageously included when a water-soluble polymer of very high molecular weight such as greater than about 5,000,000 g/mol, is employed.

The components a), b), and optionally c) may be pre-mixed before feeding the blend into a device utilized for melt-extrusion. Useful devices for melt-extrusion, specifically useful extruders, are known in the art. Alternatively, the components a), b), and optionally c) may be fed separately into the extruder and blended in the device before or during a heating step. Although in some embodiments of the invention the composition or the components to be fed into the extruder may contain liquid materials, dry feed is advantageously employed in the melt-extrusion process of the present invention. The composition or the components that has or have been fed into an extruder are passed through a heated area of the extruder at a temperature which will melt or soften the mixture or at least one or more components thereof to form a blend throughout which the active ingredient is dispersed. The blend is subjected to melt-extrusion and caused to exit the extruder die using a take-up roll. Typical extrusion processing temperatures are from 50 to 210° C., preferably from 70 to 200° C., more preferably from 100 to 190° C. An operating temperature range should be selected that will minimize the degradation or decomposition of the active ingredient and other components of the blend during processing. The extruder used to practice the invention preferably is a commercially available model equipped to handle dry feed and having a solid conveying zone, one or multiple heating zones, and an extrusion die. It is particularly advantageous for the extruder to possess multiple separate temperature controllable heating zones. Single or multiple screw extruders, preferably twin screw extruders, can be used in the melt-extrusion process of the present invention.

The molten or softened mixture preferably has a “Melt Draw Elongation” of from 50 to 5000%, more preferably from 200 to 2500%, most preferably from 400 to 1500%. The melt draw elongation is represented by the equation ((Vf−Vi)/Vi)*100, where Vi is the film velocity at the die and Vf is the film velocity at the take up roll. The take-up roll, also designated as casting roll or chill roll, is the first surface that the molten formulation contacts after leaving the die. The roll rotation speed is controlled to provide the desired film thickness and draw down rate from the extruded material.

The extrudate is molded, preferably drawn, to a film of the desired thickness, i.e., to a thickness of at least 0.04 mm, preferably from 0.05 to 0.30 mm. The above-mentioned components a), b), c) and optionally d) in the above-mentioned weight ratios generally form a melt of sufficient melt strength that the extrudate can be drawn to a film at a draw-down ratio of 1.5 to 20, preferably 2.5 to 17, more preferably 3 to 10, most preferably 3.5 to 7. The term “draw-down ratio” as used herein is the ratio of the gap of the extruder die to the thickness of the drawn film at the take-up roll.

A mono-layered or multi-layered film can be produced according to the process of the present invention. If a multilayered film is to be produced, the produced film of a thickness of at least 0.04 mm is combined with one or more other films during or after melt-extrusion to produce a multi-layered film. For example, the extruded and drawn film layer can be combined with other films layers while it is still warm or hot or after it has been cooled down. Alternately, a melt-extruded multilayered film can be produced via coextrusion, wherein one or more of the layers are produced from the blend comprising the above-mentioned components a), b), and optionally c).

The mono- or multilayered film can be cut into dosage forms according to a known manner.

The present invention is further illustrated by the following examples which are not to be construed to limit the scope of the invention. Unless otherwise mentioned, all parts and percentages are by weight.

### Examples 1-12

The melt extruded films comprise the following materials.

| | | | Meltin |
|---|---|---|---|
| | | | (Tm)/Glass |
| | | | Transition |
| | | | (Tg) |
| Com- | | | Temperature |
| ponent | Material | Supplier | (° C.) |
| A | POLYOX ™ WSR N-80 | The Dow Chemical | Tm = 67 |
| | | Company | |
| A | POLYOX ™ WSR N-10 | The Dow Chemical | Tm = 66 |
| | | Company | |
| A | METHOCEL E50 | The Dow Chemical | Tg = 193 |
| | hydroxypropyl | Company | |
| | methylcellulose | | |
| | ether (HPMC) | | |
| A | METHOCEL E50 HPMC, | | |
| | plasticized with propylene | | |
| | glycol (PG) | | |
| A | Kollidon 90F | BASF | Tm = 165 |
| | Polyvinylpyrrolidone | | |
| B | Ibuprofen | Spectrum Chemical | Tm = 76 |
| | | & Laboratory | |
| | | Products | |
| B | Phenylephrine | Spectrum Chemical | Tm = 144 |

POLYOX™ WSR N-10 poly(ethylene oxide) polymer has a molecular weight of about 100,000 g/mol. POLYOX™ WSR N-80 poly(ethylene oxide) polymer has a molecular weight of about 200,000 g/mol. METHOCEL E50 is a Hydroxypropyl methylcellulose having a methoxyl content of 27.5 to 31% and a hydroxypropyl content of 7 to 12% and a viscosity of 40-60 mPa's, measured as a 2 weight percent aqueous solution. Kollidon 90F polyvinylpyrrolidone has a weight average molecular weight M_{w} of 1,000,000 to 1,500,000 g/mol.

Both components A and B were analyzed via Differential Scanning calorimetry to determine their thermal transitions. Samples were prepared by weighing the desired quantity of material to be analyzed (5 to 10 mg) into aluminum hermetic pans. Lids were applied and crimped prior to analysis. The scans were run from 0 to 250° C. at a heating rate of 10° C./min. The Cellulose ethers, Phenylephrine and the Kollidon 90F were dried over night at 110° C. prior to the analyses using a standard lab convection oven.

The components A and B were blended for 10 minutes using a laboratory V-blender prior to using in extrusion. Hydroxypropyl methylcellulose was dried in an oven at 40° C. for a minimum of 24 hours prior to any blending with Ibuprofen.

The melt extruded films were made using either a conventional twin screw extruder or a single screw extruder.

Twin Screw Extrusion

Conventional twin screw extrusions were generated using a Leistritz Model ZSE micro 18-mm twin-screw extruder. This machine has the capability of running both co-rotating and counter-rotating geometries by changing the gearbox and the screw elements. The unit is driven by a 2.2 KW drive motor and has a maximum screw speed of 500 rpm. The present unit has 8 barrel sections (5 diameters each) for a total 40 length/diameter process section.

Both co-rotating and counter-rotating screw geometries were used. The counter-rotating configuration was used for the majority of the samples. It consisted of two kneading block sections to enable melting and mixing in the first kneading block section and the downstream addition of a) water-soluble polymer, b) active ingredient, or c) optional additive via an open barrel section in a starve-feed mode. The co-rotating screw configuration geometry was designed to demonstrate melting, mixing, and pumping the formulation without the use of kneading blocks or traditional mixing elements.

Two Brabender Model No. FW/18/5 loss-in-weight feeders were used to feed raw materials into the feed barrel section of the extruder. Nitrogen lines were installed on the feed hoppers and the vertical PVC feed leg in order to inert the raw materials and the feed port.

A horizontally configured cast film die was attached to the end of the extruder using a custom designed adapter piece. The die was a standard 6 inch (152 mm) wide coat-hanger style design with a restrictor bar. The die lip gap was set at about 32 mil (0.81 mm) at the beginning of each experiment. The distance of the die relative to the casting unit was located 1.5 inches (38 mm) horizontally and equal to the centerline of the casting roll in the vertical direction. Film gauge was controlled by the die gap and the amount of drawdown between the die and the casting unit. The casting unit was a Killion single-roll 10-inch (254 mm) diameter casting unit with one set of nip-rolls. The casting roll temperature was maintained at 31° C. for all experiments. Film was collected on a Killion film winder.

### Single Screw Extrusion

Single Screw Extrusion was performed using a Davis Standard extruder equipped with a screw of 1.25 inch diameter (32 mm) and a length/diameter ratio of 24/1. The blend of water-soluble polymer a) and the active ingredient b) was fed into the extruder in a starve-feed mode. The extruder fed an 8 inch (203 mm) wide cast film die of coat hanger design. The die lip gap was set at about 30 mil (0.76 mm) at the beginning of each experiment. The die temperature was 140° C. in all examples. The film extrudate was fed horizontally to a 3-roll vertical stack. The top roll was rubber, the middle and bottom rolls were steel. The temperature of the rolls was controlled using a Mokon Compu-Mate 100 controller. The film was conveyed via the roll stack to a film winding station. A K-Tron model KCLKT-20 feeder was used in the gravimetric mode to feed the extruder.

Table 1 summarizes the results for the extrusion using the twin screw and single screw extruders.

TABLE 1

| Example | | | | | % B, based | Melt Draw | Draw-Down |
|---|---|---|---|---|---|---|---|
| Number | Extruder | Film Thickness | Component A | Component B | On Composition | Elongation (%) | Ratio |
| 1 | Twin-screw, | 5 mil (0.13 mm) | POLYOX N-80 | Ibuprofen | 25 | 997 | 6.4 |
| | co-rotating | | | | | | |
| 2 | Twin-screw, | 5 mil (0.13 mm) | POLYOX N-80 | Ibuprofen | 25 | 891 | 6.4 |
| | counter rotating | | | | | | |
| 3 | Twin-screw, | 2 mil (0.05 mm) | POLYOX N-80 | Ibuprofen | 25 | 2377 | 16 |
| | co-rotating | | | | | | |
| 4 | Twin-screw, | 10 mil (0.25 mm) | POLYOX N-80 | Ibuprofen | 25 | 448 | 3.2 |
| | co-rotating | | | | | | |
| 5 | Twin-screw, | 5 mil (0.13 mm) | Plasticized HPMC | Ibuprofen | 25 | 1081 | 6.4 |
| | co-rotating | | (35% PG) | | | | |
| Control A* | Twin-screw, | 5 mil (0.13 mm) | Plasticized HPMC | None | 0 | 997 | 6.4 |
| | co-rotating | | (35% PG) | | | | |
| 6 | Twin-screw, | 5 mil (0.13 mm) | POLYOX N-80 | Phenylephrine - | 25 | 891 | 6.4 |
| | co-rotating | | | HCl | | | |
| Control B* | Twin-screw, | 5 mil (0.13 mm) | POLYOX N-80 | None | 0 | 891 | 6.4 |
| | co-rotating | | | | | | |
| 7 | Single Screw | 5 mil (0.13 mm) | POLYOX N-80 | Ibuprofen | 25 | 1058 | 6 |
| 8 | Single Screw | 2 mil (0.05 mm) | POLYOX N-80 | Ibuprofen | 25 | 2400 | 15 |
| 9 | Single Screw | 10 mil (0.25 mm) | POLYOX N-80 | Ibuprofen | 25 | 425 | 3 |
| 10 | Single Screw | 5 mil (0.13 mm) | POLYOX N-10 | Ibuprofen | 25 | 1244 | 6 |
| 11 | Single Screw | 5 mil (0.13 mm) | Plasticized HPMC | Ibuprofen | 25 | 556 | 6 |
| | | | (15% PG) | | | | |
| 12 | Single Screw | 5 mil (0.13 mm) | Plasticized HPMC | Ibuprofen | | | 6 |
| | | | (20% PG) | | | | |
| Control C* | Single Screw | 5 mil (0.13 mm) | POLYOX N-80 | None | 0 | 25 | 588 |
| Control D* | Single Screw | 5 mil (0.13 mm) | Plasticized HPMC | None | 0 | 588 | 6 |
| | | | (40% PG) | | | | |

*without active ingredient

Table 2 summarizes the extruder conditions for the twin screw extruder experiments; and Table 3 summarizes the extruder conditions for the single screw extruder experiments.

TABLE 2

| Example | 1 | 2 | 3 | 4 | 5 | 6 | Control A | Control B |
|---|---|---|---|---|---|---|---|---|
| Rate [g/h] | 1396 | 12000 | 1200 | 1026 | 1300 | 1200 | 1500 | 1500 |
| screw speed [rpm] | 400 | 35 | 250 | 250 | 300 | 35 | 300 | 400 |
| Torque [percent] | 70 | 74 | 38 | 44 | 31 | 74 | 40 | 79 |
| Die pressure [kPa]] | 2620 | 3792 | 1586 | 2137 | 1448 | 3792 | 1862 | 3999 |
| Temp. Zone 1 [° C.] | 60 | 60 | 60 | 60 | 70 | 60 | 90 | 60 |
| Temp. Zone 2 [° C.] | 124 | 125 | 125 | 125 | 135 | 125 | 145 | 125 |
| Temp. Zone 3 [° C.] | 130 | 135 | 140 | 140 | 135 | 135 | 160 | 140 |
| Temp. Zone 4 [° C.] | 130 | 135 | 140 | 140 | 135 | 135 | 160 | 140 |
| Temp. Zone 5 [° C.] | 130 | 135 | 140 | 140 | 135 | 135 | 160 | 140 |
| Temp. Zone 6 [° C.] | 130 | 135 | 140 | 140 | 135 | 135 | 160 | 140 |
| Temp. Zone 7 [° C.] | 130 | 135 | 140 | 140 | 135 | 135 | 160 | 140 |
| Temp. Zone 8 [° C.] | 130 | 140 | 140 | 140 | 135 | 140 | 160 | 140 |
| Temp. die zone [° C.] | 130 | 140 | 140 | 140 | 135 | 140 | 160 | 140 |
| Cast roll temp [° C.] | 31 | 31 | 31 | 31 | 31 | 31 | 31 | 31 |
| Film width [mm] | 88.9 | 98.4 | 98.4 | 88.9 | 82.5 | 98.4 | 88.9 | 98.4 |

TABLE 3

| | Screw | Melt | | Film | Casting Roll | Casting Roll | Barrel | Barrel | Barrel |
|---|---|---|---|---|---|---|---|---|---|
| | Speed | Pressure | Rate | Width | Speed | Temperature | Zone 1 | Zone 2 | Zone 3 |
| Example | (rpm) | (kPa) | (kg/hour) | (mm) | (mm per min) | (deg. C.) | (deg C.) | (deg C.) | (deg C.) |
| 7 | 45 | 13790 | 4.5 | 92.1 | 2438 | 19.4 | 160 | 150 | 140 |
| 8 | 45 | | 4.5 | | 7315 | | 60 | 130 | 140 |
| 9 | 45 | 13790 | 4.5 | | 1219 | | 60 | 130 | 140 |
| 10 | 25 | 11377 | 2.5 | 79.4 | 1829 | 19.4 | 70 | 120 | 120 |
| 11 | 25 | 24133 | 2.5 | | 610 | 18.9 | 70 | 130 | 140 |
| 12 | 25 | 19306 | 2.5 | 154.9 | 610 | 18.9 | 70 | 130 | 140 |
| Control C | 45 | 27580 | 4.5 | 76.2 | 3048 | 18.3 | 60 | 130 | 140 |
| Control D | 40 | 10343 | 4.5 | 154.9 | 1219 | 18.3 | 110 | 130 | 140 |

Films of the present invention loaded with an active ingredient have sufficient melt elongation to be drawn down. The films had comparable melt draw elongation and draw down ratio to films that did not contain an active ingredient in spite of the load of the active ingredient as high as 25 percent and regardless the type of process equipment.

### Example 26

### Extrusion of Polyvinylpyrrolidone

Kollidon 90F Polyvinylpyrrolidone (component A) and ibuprofen (component B) were blended at a 50/50 ratio (Kollidon 90F/ibuprofen) as described above prior to extrusion.

Film extrusion was performed using a Davis Standard extruder equipped with a general purpose screw of 1.25 inch diameter (32 mm) and a length/diameter ratio of 24/1. The extruder was outfitted with an 8 inch (203 mm) wide cast film die with a die gap of approximately 0.025 inch (0.64 mm). The extruded film was drawn away from the die and cooled using a vertical 3 roll stack. The steel casting rolls were controlled at 14.5° C. using a Mokon Compu-Mate 100 controller. The extruder setpoints were: barrel zone 1=70° C., barrel zone 2=120° C., barrel zone 3=135° C., die zone 1=135° C., die zone 2=135° C. The extruder screw rate was 25 rpm. The formulation was fed to the extruder at a rate of 2.5 kg/hour using a K-tron model KCLKT-20 feeder in gravimetric mode. A 0.005 inch (0.127 mm) thick film was easily produced. The casting roll speed was 3.5 feet per minute (1.1 m/min). The film produced had a width of 5.0 inch (127 mm).

The comparative sample to the polyvinylpyrrolidone/ibuprofen is a 49/51 ratio (POLYOX N-80/ibuprofen) blended for 10 minutes using a laboratory V-blender. Film extrusion was attempted on the same equipment as described above. The extruder set points were: barrel zone 1=60° C., barrel zone 2=100° C., barrel zone 3=100° C., die zone 1=100° C., die zone 2=100° C. The extruder screw rate was 45 rpm. The formulation was fed to the extruder at a rate of 4.5 kg/hour using a K-tron model KCLKT-20 feeder in gravimetric mode. At this process temperature, both the ibuprofen and POLYOX N-80 are completely melted. Film could not be produced due to the extremely low viscosity of the extrudate.

What is claimed is:

1. A process for producing a melt-extruded film comprising the steps of blending a) a water-soluble polymer, b) an active ingredient, and c) optional additives and subjecting the blend to melt-extrusion to produce an extruded melt and drawing the extruded melt at a draw-down ratio of from about 1.5 to about 20 to a film of a thickness of at least about 0.04 mm.

2. The process of claim 1 wherein the film is extruded to a film at a draw-down ratio of from about 2.5 to about 17.

3. The process of claim 1 wherein the optional additive is a disintegrant.

4. The process of claim 1 wherein the combined amount of the water-soluble polymer a) and the active ingredient b) is at least about 75 percent, based on the total weight of the blend.

5. The process of claim 1 wherein the amount of the active ingredient b) is from about 10 to about 60 percent, based on the total weight of the blend.

6. The process of claim 1 wherein the water-soluble polymer is a cellulose ether, a polyethylene oxide, a polyvinylpyrrolidone or a polymer comprising in polymerized form acrylic acid, methacrylic acid, a salt of acrylic acid or methacrylic acid, vinylacetate, ethylene imine, or an oxyethylene alkylether.

7. The process of claim 1 wherein the water-soluble polymer is a cellulose ether or a polyethylene oxide or a combination of a cellulose ether and a polyethylene oxide.

8. The process of claim 1 wherein the amount of the water-soluble polymer a) is from about 15 to about 90 percent, based on the total weight of the blend.

9. The process of claim 1 for producing a mono-layered melt-extruded film.

10. The process claim 1 wherein the water-soluble polymer a) has a softening point above the melting point of the active ingredient b).

11. The process of claim 1 wherein the blend is subjected to melt-extrusion, caused to exit an extruder die and drawn to a film using a take-up roll to provide a film of a melt draw elongation of from about 50 to about 5000%, wherein the melt draw elongation=((Vf−Vi)/Vi)*100, where Vi is the film velocity at the extruder die and Vf is the film velocity at the take-up roll.

12. The process of claim 11 wherein the melt draw elongation is from about 200 to about 2500%.

13. The process of claim 1 for producing a film of a thickness of from about 0.05 mm to about 0.30 mm.

14. The process of claim 1 wherein the film of a thickness of at least about 0.04 mm is combined with one or more other films during or after melt-extrusion to produce a multi-layered film.

15. A melt-extruded film producible according to claim 1.
